(19) United States
(12) Patent Application Publication
(10) Pub. No.: US 2013/0165551 A1
(43) Pub. Date: Jun. 27, 2013

(54) ADHESIVE RESIN COMPOSITION FOR HDD MOTOR AND HDD MOTOR FABRICATED USING THE SAME

(71) Applicants: Kun KIM, Suwon (KR); Hyung Kyu Kim, Daejeon (KR)

(72) Inventors: Kun KIM, Suwon (KR); Hyung Kyu Kim, Daejeon (KR)

(73) Assignee: SAMSUNG ELECTRO-MECHANICS CO., LTD.

(21) Appl. No.: 13/403,426

(22) Filed: Feb. 23, 2012

(30) Foreign Application Priority Data
Dec. 22, 2011 (KR) 10-2011-0140028

(51) Int. Cl. C09J 163/00; C09J 11/04

(52) U.S. Cl. 523/466; 523/400

(57) ABSTRACT

There are provided an adhesive resin composition for a HDD motor and a HDD motor fabricated using the same. The adhesive resin composition for a HDD motor includes: 25 to 35 parts by weight of a bisphenol E-epoxy resin; 10 to 25 parts by weight of an epoxy resin; 10 to 20 parts by weight of mercaptan; and 5 to 15 parts by weight of imidazole. The constituents of an epoxy adhesive material may be controlled, such that a curing speed may be increased, as compared to the case of the related art, thereby enhancing working efficiency and reliability.

### CROSS-REFERENCE TO RELATED APPLICATIONS

This application claims the priority of Korean Patent Application No. 10-2011-0140028 filed on Dec. 22, 2011, in the Korean Intellectual Property Office, the disclosure of which is incorporated herein by reference.

### BACKGROUND OF THE INVENTION

1. Field of the Invention

The present invention relates to an adhesive resin composition for a HDD motor, capable of ensuring excellent reliability by preventing a generation of outgas, and a HDD motor fabricated using the same.

2. Description of the Related Art

A hard disk drive (HDD), as an information storage device, uses a read/write head to read data stored on a disk or to write data to a disk.

Such a HDD needs a disk driver to drive the disk and the disk driver may be provided with a small spindle motor.

The small spindle motor may include a hydrodynamic bearing assembly. The hydrodynamic bearing assembly has a lubricating fluid interposed between a shaft as a rotating component and a sleeve as a fixed component, to thereby support the shaft using fluid pressure generated in the lubricating fluid.

In fabricating the hydrodynamic bearing assembly, an epoxy adhesive is generally used to bond a base and a core, a base and a pulling plate, and/or a hub and a magnet.

However, such a bond using the epoxy adhesive, may have a problem in terms of ensuring reliability due to outgas generation.

In addition, a high temperature curing process is required for an extended period of time, in turn causing a deterioration in working efficiency thereof.

Accordingly, consumer demand for guaranteed reliability and quality in a hard disk drive (HDD) motors is increasing. Specifically, due to the outgas problem of a motor assembled with the assistance of an adhesive, an error may occur in the storage performance of the HDD. Therefore, quantitative standardization of an outgas from an adhesive material and tests for guaranteeing reliability and quality of an HDD in advance, are now necessarily emphasized before the mass-production of device components.

(Patent Document 1) Japanese Patent Laid-Open Publication No. 2010-013493

### SUMMARY OF THE INVENTION

An aspect of the present invention provides an adhesive resin composition for a HDD motor, capable of ensuring excellent reliability by preventing a generation of outgas, and a HDD motor fabricated using the same.

According to an aspect of the present invention, there is provided an adhesive resin composition for a HDD motor, including: 25 to 35 parts by weight of a bisphenol E-epoxy resin; 10 to 25 parts by weight of an epoxy resin; 10 to 20 parts by weight of mercaptan; and 5 to 15 parts by weight of imidazole.

The adhesive resin composition may further include 1 to 10 parts by weight of silica.

The adhesive resin composition may further include 1 to 3 parts by weight of a stabilizer.

The epoxy resin may include at least one selected from a group consisting of a bisphenol A type epoxy resin, a bisphenol F type epoxy resin, a bisphenol S type epoxy resin, a bisphenol AF type epoxy resin, a biphenyl type epoxy resin, a naphthalene type epoxy resin, a fluorine type epoxy resin, a novolac type epoxy resin and a glycidyl ether type epoxy resin.

The adhesive resin composition may allow for bonding between at least one pair selected from a group consisting of a base and a core, a base and a pulling plate, and a hub and a magnet of the HDD motor.

According to another aspect of the present invention, there is provided a HDD motor including an adhesive resin composition, wherein the adhesive resin composition includes: 25 to 35 parts by weight of a bisphenol E-epoxy resin; 10 to 25 parts by weight of an epoxy resin; 10 to 20 parts by weight of mercaptan; and 5 to 15 parts by weight of imidazole.

The adhesive resin composition may further include 1 to 10 parts by weight of silica.

The adhesive resin composition may further include 1 to 3 parts by weight of a stabilizer.

The epoxy resin may include at least one selected from a group consisting of a bisphenol A type epoxy resin, a bisphenol F type epoxy resin, a bisphenol S type epoxy resin, a bisphenol AF type epoxy resin, a biphenyl type epoxy resin, a naphthalene type epoxy resin, a fluorine type epoxy resin, a novolac type epoxy resin and a glycidyl ether type epoxy resin.

The adhesive resin composition may allow for bonding between at least one pair selected from a group consisting of a base and a core, a base and a pulling plate, and a hub and a magnet of the HDD motor.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a HDD motor illustrating an area of the HDD motor to which an adhesive resin composition is applied according to an embodiment of the present invention;

FIG. 2 is a graph showing tensile strength in accordance with curing times at different temperatures when an adhesive resin composition according to the related art is used; and

FIG. 3 is a graph showing tensile strength in accordance with curing times at different temperatures when an adhesive resin composition according to an embodiment of the present invention is used.

### DETAILED DESCRIPTION OF THE INVENTION

The embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

Hereinafter, exemplary embodiments of the present invention will be described in detail with reference to the accompanying drawing.

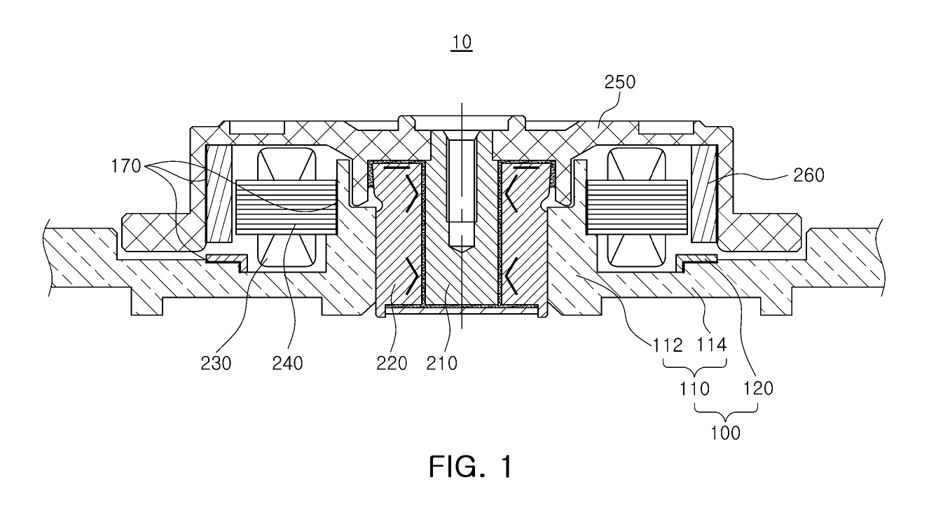

FIG. 1 is a schematic perspective view of a HDD motor illustrating an area of the HDD motor to which an adhesive resin composition is applied according to an embodiment of the present invention.

Referring to FIG. 1, an adhesive resin composition for a HDD motor according to an embodiment of the present invention may include: 25 to 35 parts by weight of a bisphenol E-epoxy resin; 10 to 25 parts by weight of an epoxy resin; 10 to 20 parts by weight of mercaptan; and 5 to 15 parts by weight of imidazole.

The above configuration will be explained below in detail.

The adhesive resin composition for a HDD motor according to the embodiment of the present invention may include 25 to 35 parts by weight of bisphenol E-epoxy resin.

The bisphenol E-epoxy resin may be 4,4′-ethylidene-bisphenol and represented by Formula 1 below.

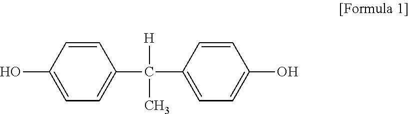 [SMILES: CC(c1ccc(O)cc1)c1ccc(O)cc1]

The bisphenol E-epoxy resin may serve to maintain adhesion strength at a room temperature and a high temperature when a base 110 and a core 240, the base 110 and a pulling plate 120, and a hub 250 and a magnet 260 of the HDD motor, to be described later, are bonded individually.

The bisphenol E-epoxy resin may be contained in an amount of 25 to 35 parts by weight and, if the amount is less than 25 parts by weight, adhesive strength may be reduced. On the other hand, when the amount exceeds 35 parts by weight, an adhesive resin-cured product may have decreased coating properties.

In addition, the adhesive resin composition for a HDD motor may include 10 to 25 parts by weight of an epoxy resin.

The epoxy resin may maintain adhesion strength at a room temperature and a high temperature when the components are bonded using the adhesive resin composition.

The epoxy resin may be at least one selected from a group consisting of a bisphenol A type epoxy resin, a bisphenol F type epoxy resin, a bisphenol S type epoxy resin, a bisphenol AF type epoxy resin, a biphenyl type epoxy resin, a naphthalene type epoxy resin, a fluorine type epoxy resin, a novolac type epoxy resin and a glycidyl ether type epoxy resin; however, any adhesive epoxy resin may be used without particular limitation thereof.

The epoxy resin may be contained in an amount of 10 to 25 parts by weight and, if the amount is less than 10 parts by weight, adhesive strength may be reduced. On the other hand, when the amount exceeds 25 parts by weight, an adhesive resin-cured product may have decreased coating properties. The adhesive resin composition for a HDD motor according to an embodiment of the present invention may include 10 to 20 parts by weight of mercaptan.

The mercaptan may serve as a curing agent to accelerate curing of the adhesive resin composition for a HDD motor.

According to the embodiment of the present invention, mercaptan is contained in an amount of 10 to 20 parts by weight as a curing agent as described above, such that a curing speed maybe increased to five times or more, as compared to the related art, thus enhancing working efficiency and preventing a deterioration in reliability caused by an outgas generation.

If the amount in which mercaptan is added is less than 10 parts by weight, curing speed-increasing effects may not be attained. On the other hand, the amount exceeds 20 parts by weight, the adhesive resin composition may have deteriorated physical properties due to the addition of the excessive amount.

The adhesive resin composition for a HDD motor according to the embodiment of the present invention may include 5 to 15 parts by weight of imidazole.

The imidazole may serve as a curing agent to accelerate curing of the adhesive resin composition for a HDD motor.

According to the embodiment of the present invention, imidazole is contained in an amount of 5 to 15 parts by weight as the curing agent, such that a curing speed may be increased to five times or more, as compared to the related art, thus enhancing working efficiency and preventing a deterioration in reliability caused by an outgas generation.

If the amount in which imidazole is added is less than 5 parts by weight, curing speed-increasing effects may not be attained. On the other hand, the amount exceeds 15 parts by weight, the adhesive resin composition may have deteriorated physical properties due to the addition of the excessive amount.

The adhesive resin composition may further include 1 to 10 parts by weight of silica.

The silica may regulate viscosity of the adhesive resin composition, control working efficiency, improve adhesive strength of the adhesive resin composition and prevent thermal expansion thereof.

The silica may be contained in an amount of 1 to 10 parts by weight and, if the amount is less than 1 part by weight, the foregoing effects, that is, viscosity regulation, adhesive strength improvements, thermal expansion prevention and working efficiency control, may not be attained. On the other hand, when the amount exceeds 10 parts by weight, the adhesive resin composition may have deteriorated physical properties due to the addition of the excessive amount. The adhesive resin composition may include 1 to 3 parts by weight of a stabilizer.

The stabilizer may serve as a stabilizing agent for the adhesive resin composition.

The stabilizer may be contained in an amount of 1 to 3 parts by weight and, if the amount is less than 1 part by weight, stabilizing agent effects may not be imparted to the adhesive resin composition. On the other hand, when the amount exceeds 3 parts by weight, the adhesive resin composition may have deteriorated physical properties due to the addition of the excessive amount.

According to another embodiment of the present invention, a HDD motor 10 may include an adhesive resin composition 170, the adhesive resin composition including: 25 to 35 parts by weight of a bisphenol E-epoxy resin; 10 to 25 parts by weight of an epoxy resin; 10 to 20 parts by weight of mercaptan; and 5 to 15 parts by weight of imidazole.

The adhesive resin composition 170 may further include 1 to 10 parts by weight of silica.

The adhesive resin composition 170 may further include 1 to 3 parts by weight of a stabilizer.

The epoxy resin maybe at least one selected from a group consisting of a bisphenol A type epoxy resin, a bisphenol F type epoxy resin, a bisphenol S type epoxy resin, a bisphenol AF type epoxy resin, a biphenyl type epoxy resin, a naphthalene type epoxy resin, a fluorine type epoxy resin, a novolac type epoxy resin and a glycidyl ether type epoxy resin; however, the present invention is not limited thereto.

The adhesive resin composition may allow for bonding between at least one pair selected from the group consisting of the base 110 and the core 240, the base 110 and the pulling-plate 120, and the hub 250 and the magnet 260, without being particularly limited thereto.

Hereinafter, a HDD motor according to another embodiment of the present invention will be described; however, a description overlapping with that of the foregoing embodiment of the present invention will be omitted.

The HDD motor 10 including a base assembly for a motor (100, hereinafter referred to as ‘base assembly’) may include; a base assembly 100 having a base for a motor (110, hereinafter referred to as ‘base’), a sleeve 220 supporting a rotation of a rotating member, and a core 240 having a coil 230 wound therearound.

First, terms regarding directions are defined. Referring to FIG. 1, an axial direction may refer to a vertical direction based on a shaft 210, and an outer direction or an inner direction may refer to a direction towards an outer edge of a hub 250 based on the shaft 210 or a direction towards the center of the shaft 210 based on the outer edge of the hub 250.

In addition, a circumferential direction may refer to a rotation direction of the shaft 210, that is, a rotating direction along an outer peripheral surface of the shaft 210.

The base assembly 100 may include the base 110 and a pulling plate 120, wherein the base 110 may be coupled with the core 240 around which the coil 230 is wound.

In other words, the base 110, a component of a fixed member supporting the rotating member including the hub 250, may be a fixed structure to which the coil 230 generating a predetermined magnitude of electromagnetic force at the time of applying power thereto and the core 240 having the coil 230 wound therearound are coupled.

According to another embodiment of the present invention, the coupling of the base 110 and the core 240 is performed using the adhesive resin composition 170 according to the embodiment of the present invention, such that the curing speed may be increased as compared to the case of the related art, thereby improving working efficiency and enhancing reliability due to a reduction in an outgas generation.

In this regard, the base 110 may include a protrusion part 112 and a body part 114, the protrusion part 112 having an inner peripheral surface coupled to an outer peripheral surface of the sleeve 220 supporting the shaft 210 to thereby support the sleeve 220.

That is, the protrusion part 112 may have a hollow and protrude upwardly in the axial direction. Here, the hollow may have the sleeve 220 inserted thereinto and coupled thereto by a method such as welding, bonding, press-fitting, or the like, and the sleeve 220 supports the shaft 210.

In addition, the protrusion part 112 may have the core 240 coupled to an outer peripheral surface thereof, the core 240 having the coil 230 wound therearound. Rigidity needs to be secured in order to secure rotation stability of the motor 10 according to the embodiment of the present invention.

In this regard, the pulling plate 120 may be coupled to the body part 114 of the base 110 and prevent excessive floating of the rotating member including the shaft 210 and the hub 250.

More particularly, the pulling plate 120 may be coupled to the body part 114 through a coupling method such as bonding or like, the body part 114 corresponding to a bottom surface of the magnet 260 coupled to the hub 250, and may have magnetic attraction force acting between the pulling plate 120 and the magnet 260.

The shaft 210 and the hub 250, components of the rotating member of the motor 10 according to the embodiment of the present invention, need to be floated at a predetermined height so as to be stably rotated. However, in the case in which the shaft 210 and the hub 250 are floated at a height higher than a pre-designed floating height, it may have a negative effect on performance.

In this case, in order to prevent the excessive floating of the shaft 210 and the hub 250 as the components of the rotating member, the pulling plate 120 may be coupled to the base 110. Therefore, the excessive floating of the rotating member may be prevented by the magnetic attraction force acting between the pulling plate 120 and the magnet 260.

According to another embodiment of the present invention, the coupling of the base 110 and the pulling plate 120 is performed using the adhesive resin composition 170 according to the embodiment of the present invention, such that the curing speed may be increased as compared to the case of the related art, thereby improving working efficiency and enhancing reliability due to a reduction in an outgas generation.

The shaft 210, a rotating component coupled to the hub 250 and rotating therewith may be supported by the sleeve 220.

The sleeve 220 may support the shaft 210 and the hub 250, the components of the rotating member. More particularly, the sleeve 220 may support the shaft 210 such that an upper end of the shaft 210 protrudes upwardly in the axial direction and may be formed by forging Cu or Al or sintering a Cu—Fe based alloy powder or a SUS based power.

In addition, the sleeve 220 may include a shaft hole having the shaft 210 inserted thereinto such that the sleeve 220 and the shaft 210 have a micro clearance therebetween, and the micro clearance may be filled with oil O to thereby stably support the shaft 210 by radial dynamic pressure via the oil O.

The hub 250, a rotating structure rotatably provided with respect to the fixed member including the base 110, may include the magnet 260 having an annular ring shape. Here, the magnet 260 may correspond to the core 240 while having a predetermined gap therebetween.

In this regard, the magnet 260 may receive rotational driving force of the motor 10 according to the present invention by interaction with the coil 230 wound around the core 240.

According to another embodiment of the present invention, coupling of the hub 250 and the magnet 260 is performed using the adhesive resin composition 170 according to the embodiment of the present invention, such that the curing speed may be increased as compared to the case of the related art, thereby improving working efficiency and enhancing reliability due to a reduction in an outgas generation.

According to another embodiment of the present invention, the adhesive resin composition 170 may include: 25 to 35 parts by weight of a bisphenol E-epoxy resin; 10 to 25 parts by weight of an epoxy resin; 10 to 20 parts by weight of mercaptan; and 5 to 15 parts by weight imidazole, such that the curing speed may be increased as compared to the case of the related art, thereby improving working efficiency and enhancing reliability due to a reduction in an outgas generation.

A method of fabricating the HDD motor 10 according to the embodiment of the present invention may be substantially the same as a fabrication method commonly used in the related art, except that bonding of at least one pair selected from the group consisting of the base 110 and the core 240, the base 110 and the pulling-plate 120, and the hub 250 and the magnet 260 is performed by applying the adhesive resin composition 170 according to the embodiment of the present invention therebetween.

The following Table 1 shows comparison results of tensile strength in accordance with curing times at different temperatures when an adhesive resin composition according to the related art is used.

Measurements of tensile strength were undertaken by a general method in which tensile strength of a HDD motor fabricated by varying curing times at different temperatures is measured; however, the present invention is not particularly limited thereto.

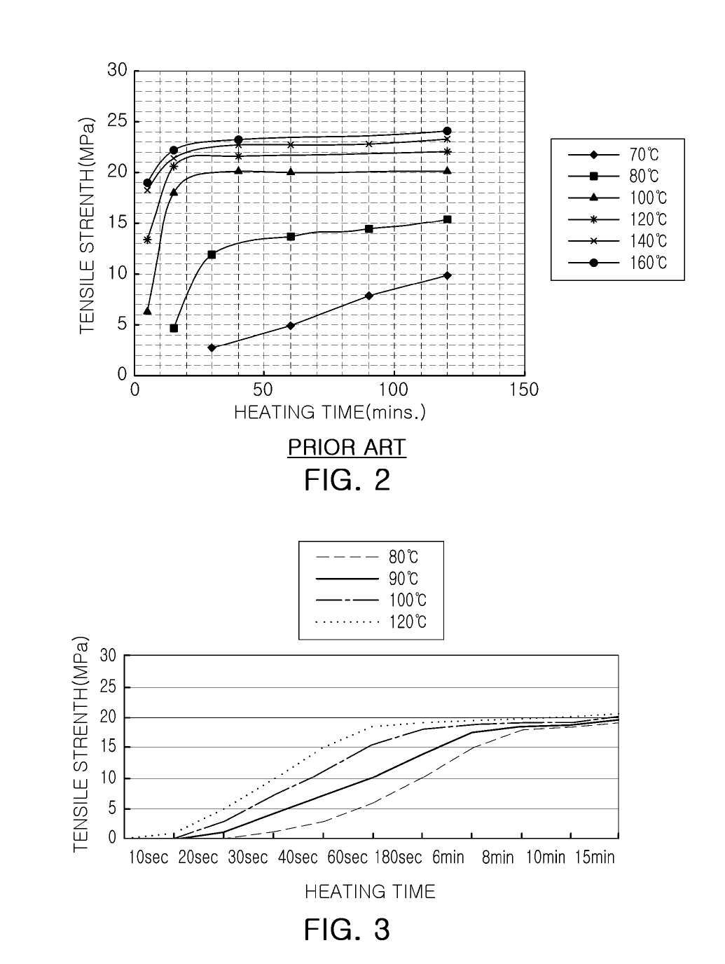

FIG. 2 is a graph showing tensile strength in accordance with curing times at different temperatures when an adhesive resin composition according to the related art is used.

TABLE 1

| | time | | | | | |
|---|---|---|---|---|---|---|
| | Tensile strength(MPa, Kg/cm²) | | | | | |
| temperature | 5 min | 15 min | 30 min | 60 min | 90 min | 120 min |
| 70□ | — | — | 2.8 | 4.9 | 7.8 | 9.9 |
| 80□ | — | 4.7 | 11.9 | 13.8 | — | 15.3 |
| 100□ | 6.0 | 17.9 | 20.0 | — | — | 20.2 |
| 120□ | 13.2 | 20.6 | 21.7 | — | — | 22.2 |
| 140□. | 18.3 | 21.3 | 22.6 | — | — | 23.4 |
| 160□. | 18.9 | — | — | — | — | 24.2 |

Referring to Table 1 and FIG. 2, in the case of using the adhesive resin composition according to the related art, it was confirmed that tensile strength was 17.9 MPa when curing was performed at 100° C. for 15 minutes.

The following Table 2 shows comparison results of tensile strength in accordance with curing times at different temperatures when an adhesive resin composition according to an embodiment of the present invention is used.

FIG. 3 is a graph showing tensile strength in accordance with curing times at different temperatures when an adhesive resin composition according to an embodiment of the present invention is used.

More particularly, the adhesive resin composition according to the embodiment of the present invention was prepared to include 30 parts by weight of a bisphenol E-epoxy resin, 20 parts by weight of an epoxy resin, 20 parts by weight of mercaptan and 10 parts by weight of imidazole.

In addition, the adhesive resin composition further includes 5 parts by weight of silica.

TABLE 2

| | time | | | | | | | | |
|---|---|---|---|---|---|---|---|---|---|
| | Tensile strength (MPa, Kg/cm²) | | | | | | | | |
| temperature | 20 sec | 30 sec | 40 sec | 1 min | 3 min | 6 min | 8 min | 10 min | 15 min |
| 80□ | — | 1.0 | 3.0 | 6.0 | 10.0 | 15.0 | 17.9 | 18.5 | 19.0 |
| 90□ | 1.0 | 4.0 | 7.0 | 10.0 | 14.0 | 17.4 | 18.5 | 18.9 | 19.6 |
| 100□ | 3.0 | 7.0 | 11.0 | 15.5 | 18.1 | 18.8 | 19.0 | 19.1 | 20.1 |
| 120□ | 5.0 | 10.0 | 15.0 | 18.5 | 19.0 | 19.4 | 19.7 | 20.1 | 20.6 |

Referring to Table 2 and FIG. 3 above, in the case of using the adhesive resin composition according to the embodiment of the present invention, it can be seen that tensile strength was 18.1 MPa when curing was performed at 100° C. for 3 minutes.

That is, the curing speed may be increased to five times or more in the case in which the adhesive resin composition according to the embodiment of the present invention was used, as compared to the case in which the adhesive resin composition according to the related art was used, thus enhancing working efficiency and manufacturability.

Moreover, a deterioration in reliability due to an outgas generation may be prevented through a reduction in the curing time, thereby realizing a HDD motor having excellent reliability.

As set forth above, according to the embodiments of the present invention, a HDD motor can be fabricated using an adhesive resin composition for a HDD motor, prepared by controlling constituents and contents of an epoxy adhesive, whereby working efficiency can be improved and reliability in the motor can be enhanced through a reduction of an outgas generation.

While the present invention has been shown and described in connection with the embodiments, it will be apparent to those skilled in the art that modifications and variations can be made without departing from the spirit and scope of the invention as defined by the appended claims.

What is claimed is:

1. An adhesive resin composition for a HDD motor, comprising: 25 to 35 parts by weight of a bisphenol E-epoxy resin; 10 to 25 parts by weight of an epoxy resin; 10 to 20 parts by weight of mercaptan; and 5 to 15 parts by weight of imidazole.

2. The composition of claim 1, wherein the adhesive resin composition further includes 1 to 10 parts by weight of silica.

3. The composition of claim 1, wherein the adhesive resin composition further includes 1 to 3 parts by weight of a stabilizer.

4. The composition of claim 1, wherein the epoxy resin is at least one selected from a group consisting of a bisphenol A type epoxy resin, a bisphenol F type epoxy resin, a bisphenol S type epoxy resin, a bisphenol AF type epoxy resin, a biphenyl type epoxy resin, a naphthalene type epoxy resin, a fluorine type epoxy resin, a novolac type epoxy resin and a glycidyl ether type epoxy resin.

5. The composition of claim 1, wherein the adhesive resin composition allows for bonding between at least one pair selected from a group consisting of a base and a core, a base and a pulling plate, and a hub and a magnet of the HDD motor.

6. A HDD motor, comprising an adhesive resin composition including 25 to 35 parts by weight of a bisphenol E-epoxy resin;
10 to 25 parts by weight of an epoxy resin; 10 to 20 parts by weight of mercaptan; and 5 to 15 parts by weight of imidazole.

7. The HDD motor of claim 6, wherein the adhesive resin composition further includes 1 to 10 parts by weight of silica.

8. The HDD motor of claim 6, wherein the adhesive resin composition further includes 1 to 3 parts by weight of a stabilizer.

9. The HDD motor of claim 6, wherein the epoxy resin is at least one selected from a group consisting of a bisphenol A type epoxy resin, a bisphenol F type epoxy resin, a bisphenol S type epoxy resin, a bisphenol AF type epoxy resin, a biphenyl type epoxy resin, a naphthalene type epoxy resin, a fluorine type epoxy resin, a novolac type epoxy resin and a glycidyl ether type epoxy resin.

10. The HDD motor of claim 6, wherein the adhesive resin composition allows for bonding between at least one pair selected from a group consisting of a base and a core, a base and a pulling plate, and a hub and a magnet of the HDD motor.
